(19) United States
(12) Patent Application Publication
(10) Pub. No.: US 2008/0292184 A1
(43) Pub. Date: Nov. 27, 2008

(54) Apparatus and method for automatically adjusting white balance

(75) Inventors: Keun Woo Park, Suwon (KR); Won Tae Choi, Yongin (KR); Tae Eung Kim, Yongin (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/984,309

(22) Filed: Nov. 15, 2007

(30) Foreign Application Priority Data
Nov. 30, 2006 (KR) 10-2006-0120048

(51) Int. Cl. G06K 9/00; H04N 9/73

(52) U.S. Cl. 382/168; 348/223.1; 382/169; 382/167; 348/E09.051

(57) ABSTRACT

Provided is an apparatus for automatically adjusting white balance, the apparatus including an Image Signal Processing (ISP) unit that processes image data; a first histogram setting unit that is connected to the ISP unit, stores the number of pixels corresponding to each Cb and Cr value of the image data applied from the ISP unit so as to set a first histogram, and sets an effective range of the first histogram; a second histogram setting unit that is connected to the first histogram setting unit, subdivides the first histogram included in the effective range so as to set a second histogram, and applies a weight to the second histogram; and a lean setting unit that is connected to the second histogram setting unit, applies preset lean values to the second histogram, to which the weight has been applied, so as to calculate a lean correction value, and delivers the calculated correction value to the ISP unit.

### BRIEF DESCRIPTION OF THE DRAWINGS

FIG. 1 is a flow chart sequentially showing a conventional method for adjusting white balance

FIG. 2 is a block diagram schematically showing an apparatus for automatically adjusting white balance according to an embodiment of the invention.

FIG. 3 is a block diagram of a first histogram setting unit according to the invention.

FIG. 4 is a diagram showing a first histogram according to the invention.

FIG. 5 is a block diagram of a second histogram setting unit according to the invention.

FIG. 6 is a diagram showing a second histogram according to the invention.

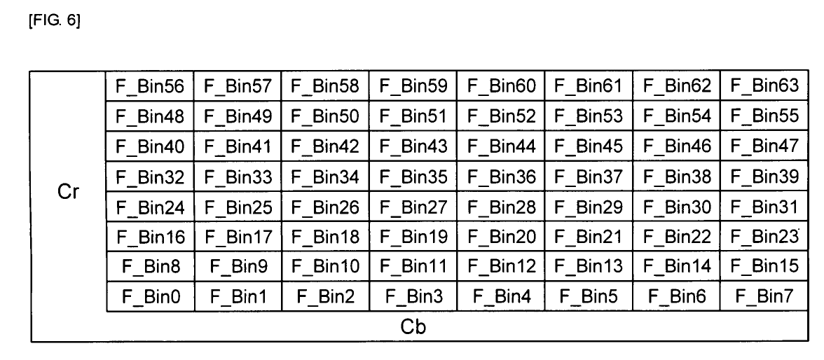

FIG. 7 is a diagram showing lean values according to the invention.

FIG. 8 is a flow chart showing a method for automatically adjusting white balance according to an embodiment of the invention.

FIG. 9 is a flow chart showing a process of setting a second histogram.

FIG. 10 is a flow chart showing a process of setting an effective-range central value.

FIG. 11 is a flow chart showing a process of applying a weight.

FIG. 12 is a flow chart showing a process of calculating a lean correction value.

### DESCRIPTION FOR KEY ELEMENTS IN THE DRAWINGS

110: ISP unit
120: first histogram setting unit
121: RGB average calculation section
122: first histogram setting section
123: effective-range central value setting section
124: first CbCr distribution analyzing section
125: effective range setting section
130: second histogram setting unit
131: second histogram setting section
132: second CbCr distribution analyzing section
133: weight applying section
140: lean setting unit

### DETAILED DESCRIPTION OF THE PREFERRED EMBODIMENTS

### Object of the Invention

### Related Field and Prior Art of the Invention

The present invention relates to an apparatus and method for automatically adjusting white balance, which applies a low weight to a region of image data, in which a probability that the original color thereof is gray is low, and a high weight to a region of the image data in which a probability that the original color thereof is gray is high, so that white balance is automatically adjusted.

In general, white balance adjustment is referred to as an operation in which a color detected by an imaging device through light is stored so as to accurately represent a color reflected from an object. That is, under a provided lighting, the levels of R, G, and B signals are adjusted in such a manner that a white object can be accurately reproduced as a white image.

When an identical object is imaged by an image device such as a digital camera or digital video camera, the appearance of an image color differs depending on various light source conditions such as a white lamp, a fluorescent lighting, and sunlight.

Eyes of human beings are adapted to various light sources so as to have color constancy such that a white color can be felted as a white color. In a case of imaging devices, however, R, G, and B components included in light sources of which the color temperatures are different from each other are reflected. Therefore, when the color temperature of a light source is high, a white color including a blue color is reproduced. When the color temperature of a light source is low, a white color including a red color is reproduced.

Accordingly, studies on the white balance adjustment are being carried out so that image data taken by an image device can be clearly displayed.

Hereinafter, a conventional method for adjusting white balance will be described in detail with reference to accompanying drawings.

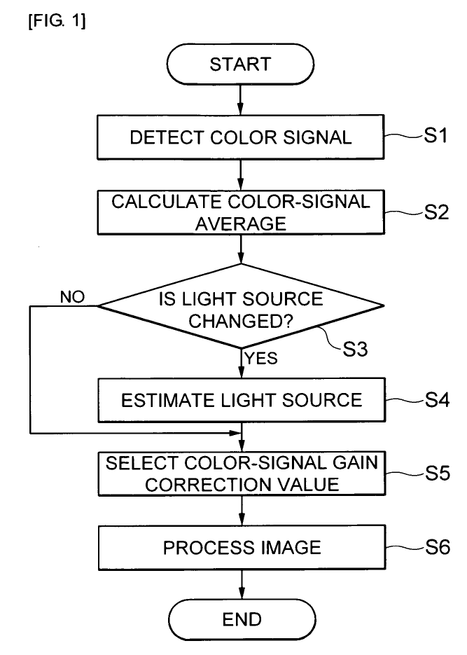

FIG. 1 is a flow chart sequentially showing a conventional method for adjusting white balance.

As shown in FIG. 1, when an optical image of an object is input through a lens of an imaging device such as a camera, a color signal composed of R, G, and B components is detected by a light conversion element (step S1).

Then, a color-signal average is calculated from the color signals (step S2). For example, R, G, and B values of all pixels within an image are averaged by grayworld detection so as to calculate the color-signal average.

Next, it is judged from the color-signal average whether a light source is changed or not (step S3).

When it is judged at step S3 that the light source is changed, the light source is estimated from the ratio of the color signal (step S4). For example, when a color-signal average ratio of red to green and a color-signal average ratio of blue to green are included between the upper and lower limits preset for a specific light source, the light source is estimated as a current light source.

From the relation between the estimated light source and the ratio of the color signal, a color-signal gain correction value is calculated (step S5).

When it is judged at step S3 that the light source is not changed, step S5 is performed.

Then, the color-signal gain correction value and the color-signal average are added to process an image (step S6). Then, the white balance adjustment is completed.

In the conventional method, however, a light source is estimated using the relation between detected color signals, only when a light source is changed. Therefore, when a prominent color is present in image data or a specific color component enters an extracted gray region, color representation is inaccurately performed after the white balance adjustment.

### TECHNOLOGICAL OBJECT ACHIEVED BY THE INVENTION

An advantage of the present invention is that it provides an apparatus and method for automatically adjusting white balance, which applies a low weight to a region of image data, in which a probability that the original color thereof is gray is low, and a high weight to a region in which a probability that the original color thereof is gray is high, so that white balance is automatically adjusted.

### CONSTRUCTION OF THE INVENTION

According to an aspect of the invention, an apparatus for automatically adjusting white balance comprises an Image Signal Processing (ISP) unit that processes image data; a first histogram setting unit that is connected to the ISP unit, stores the number of pixels corresponding to each Cb and Cr value of the image data applied from the ISP unit so as to set a first histogram, and sets an effective range of the first histogram; a second histogram setting unit that is connected to the first histogram setting unit, subdivides the first histogram included in the effective range so as to set a second histogram, and applies a weight to the second histogram; and a lean setting unit that is connected to the second histogram setting unit, applies preset lean values to the second histogram, to which the weight has been applied, so as to calculate a lean correction value, and delivers the calculated correction value to the ISP unit.

Preferably, the first histogram setting unit includes: an RGB calculation section that calculates the averages of R, G, and B values of the image data; a first histogram setting section that is composed of a plurality of storing spaces, which are discriminated depending on the Cb and Cr values and can be expanded or reduced, analyzes the respective Cb and Cr values of the image data, and stores the number of pixels corresponding to the Cb and Cr values to each of the storing spaces so as to set the first histogram; an effective-range central value setting section that is connected to the RGB calculation section and sets an effective-range central value of the first histogram from the RGB averages of the image data; a first CbCr distribution analyzing section that is connected to the first histogram setting section and the effective-range central value setting section, calculates the average number of pixels of 16 neighboring storing spaces and the average number of pixels of four neighboring storing spaces on the basis of the set effective-range central value, and stores the average numbers; and an effective range setting section that is connected to the first CbCr distribution analyzing section and divides the average number of pixels of four neighboring storing spaces by the average number of pixels of 16 neighboring storing spaces, thereby setting an effective range.

Preferably, the respective storing spaces of the first histogram setting section sequentially have Cr and Cb ranges of 32 in the range of 0 to 255.

Preferably, when an effective-range operation value obtained by dividing the average number of pixels of the four neighboring storing spaces by the average number of pixels of the 16 neighboring storing spaces is larger than a preset effective-range threshold value, the effective range setting section sets the four neighboring storing spaces to an effective range. Further, when an effective-range operation value obtained by dividing the average number of pixels of the four neighboring storing spaces by the average number of pixels of the 16 neighboring storing spaces is smaller than a preset effective-range threshold value, the effective range setting section sets the 16 neighboring storing spaces to an effective range.

Preferably, the second histogram setting unit includes: a second histogram setting section that is composed of a plurality of storing spaces which can be expanded or reduced, subdivides the first histogram corresponding to the effective range set by the first histogram setting unit, and stores the number of corresponding pixels into each of the storing spaces so as to set the second histogram; a second CbCr distribution analyzing section that is connected to the second histogram setting section, sets nine storing spaces to one block, and then sets a storing space, in which the largest number of pixels is stored, to a peak storing space; and a weight applying section that is connected to the second CbCr distribution analyzing section, calculates a peak operation value by dividing the number of pixels of the set peak storing space by the average number of pixels of eight neighboring storing spaces, and compares the calculated peak operation value with a preset white threshold value so as to calculate and apply a weight.

Preferably, when the peak operation value is larger than the white threshold value, any one weight selected from ½, ⅓, and 0 is multiplied by the number of pixels of the peak storing space. Further, when the peak operation value is smaller than the white threshold value, any one weight selected from 2 and 3 is multiplied by the number of pixels of the peak storing space.

According to another aspect of the invention, a method for automatically adjusting white balance comprises the steps of: (a) storing the number of pixels corresponding to each Cb and Cr value of image data so as to set a first histogram; (b) setting an effective range of the set first histogram, and subdividing the first histogram included in the effective range so as to set a second histogram; (c) applying a weight to the second histogram; and (d) applying preset lean values to the second histogram, to which the weight has been applied, so as to calculate a lean correction value, and applying the calculated lean correction value to the image data.

Preferably, step (b) includes the steps of: (b-1) calculating the averages of R, G, and B values of the image data; (b-2) calculating an R operation value obtained by dividing the average of R values by the average of G values and a B operation value obtained by dividing the average of B values and the average of G values; (b-3) comparing the R and B operation values with threshold values, respectively, so as to calculate an effective-range central value of the first histogram; (b-4) calculating an effective-range operation value by dividing the average number of pixels of four neighboring storing spaces by the average number of pixels of 16 neighboring storing spaces on the basis of the calculated effective-range central value; (b-5) comparing the calculated effective-range operation value with a preset effective-range threshold value; and (b-6) when the effective-range operation value is larger than the effective-range threshold value, setting the four storing spaces to an effective range, and subdividing the four storing spaces so as to set the second histogram.

Preferably, when the effective-range operation value is smaller than the effective-range threshold value at step (b-5), the 16 neighboring storing spaces are set to an effective range, and then are subdivided so as to set the second histogram.

Preferably, the calculating of the R component of the effective-range value at step (b-3) includes the steps of: (b-31) comparing the calculated R operation value with a first R threshold value which is preset; (b-32) when the R operation value is larger than the first R threshold value, adding 128+β to the average of R values; and (b-33) setting the corrected average of R values to the R component of the effective-range central value.

Preferably, the calculating of the R component of the effective-range value at step (b-3) further includes the steps of: (b-34) when the R operation value is smaller than the first R threshold value at step (b-31), comparing the R operation value with a second R threshold value which is preset; and (b-35) when the R operation value is larger than the second R threshold value, adding 128+β to the average of R values. Further, when the R operation value is smaller than the second R threshold value at step (b-34), 128 is added to the average of R values.

Preferably, the calculating of the B component of the effective-range value at step (b-3) includes the steps of: (b-36) comparing the calculated B operation value with a first B threshold value which is preset; (b-37) when the B operation value is larger than the first B threshold value, adding 128+β to the average of B values; and (b-38) setting the corrected average of B values to the B component of the effective-range central value.

Preferably, the calculating of the B component of the effective-range value at step (b-3) includes the steps of: (b-39) when the B operation value is smaller than the first B threshold value at step (b-36), comparing the B operation value with a second B threshold value which is preset; and (b-40) when the B operation value is larger than the second B threshold value, adding 128+β to the average of B values. Further, when the B operation value is smaller than the second B threshold value at step (b-39), 128 is added to the average of B values.

Preferably, step (c) includes the steps of: (c-1) setting nine storing spaces to one block, and then setting a storing space, in which the largest number of pixels is stored, to a peak storing space; (c-2) dividing the number of pixels of the peak storing space by the average number of pixels of eight neighboring storing spaces so as to calculate a peak operation value; (c-3) comparing the calculated peak operation value with a white threshold value which is preset; (c-4) when the peak operation value is larger than the white threshold value, multiplying any one weight selected from ½, ⅓, and 0 by the number of pixels of the peak storing space so as to apply the weight.

Preferably, when the peak operation value is smaller than the white threshold value at step (c-3), any one weight selected from 2 and 3 is multiplied by the number of pixels of the peak storing space so as to apply the weight.

Preferably, step (d) includes the steps of: (d-1) calculating the total number of pixels of the second histogram, to which the weight has been applied; (d-2) applying a preset lean value to the number of pixels of each storing space of the second histogram, to which the weight has been applied; (d-3) calculating the sum total of the Cb values and the sum total of the Cr values in the second histogram; (d-4) dividing the sum total of Cb values by the total number of pixels of the second histogram so as to calculate Cb_lean, and dividing the sum total of Cr values by the total number of pixels of the second histogram so as to calculate Cr_lean; (d-5) adding the Cb and Cr values of the effective-range central value to (Cb_lean and Cr_lean) so as to calculate (Cb_error, Cr_error); (d-6) calculating an RGB value (R_error, G_error, B_error) corresponding to a YCbCr value (128, Cb_error, Cr_error), dividing the G_error by the R_error so as to calculate an R correction value, and dividing the G_error by the B_error so as to calculate a B correction value, thereby obtaining a lean correction value (R correction value, 1, B correction value); and (d-7) applying the calculated correction value to the image data.

For the purpose of clarity and simplicity, a detailed description of known functions and configurations incorporated herein is omitted to avoid making the subject matter of the present invention unclear.

Hereinafter, preferred embodiments of the present invention will be described in detail with reference to the accompanying drawings.

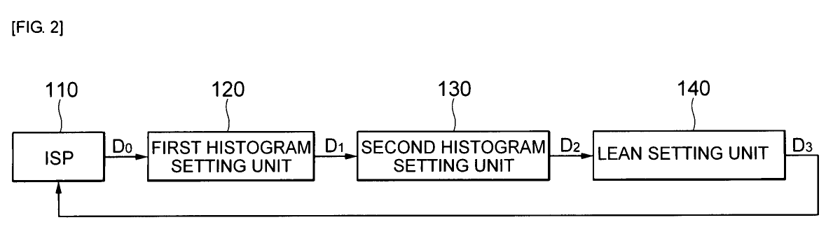

FIG. 2 is a block diagram schematically showing an apparatus for automatically adjusting white balance according to an embodiment of the invention.

As shown in FIG. 2, the apparatus for automatically adjusting white balance according to the invention includes an Image Signal Processing (ISP) unit 110, a first histogram setting unit 120, a second histogram setting unit 130, and a lean setting unit 140.

The ISP unit 110 processes image data to apply to a display device.

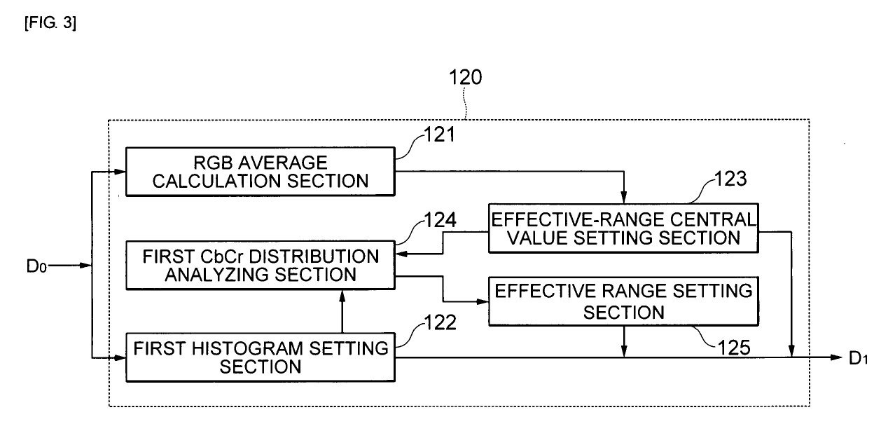

FIG. 3 is a block diagram of the first histogram setting unit 120. As shown in FIG. 3, the first histogram setting unit 120 includes an RGB average calculation section 121, a first histogram setting section 122, an effective-range central value setting section 123, a first CbCr distribution analyzing section 124, and an effective range setting section 125.

The RGB average calculation section 121 is connected to the ISP unit 110 and the effective-range central value setting section 123 and serves to calculate the averages of R, G, and B values of image data applied from the ISP unit 110.

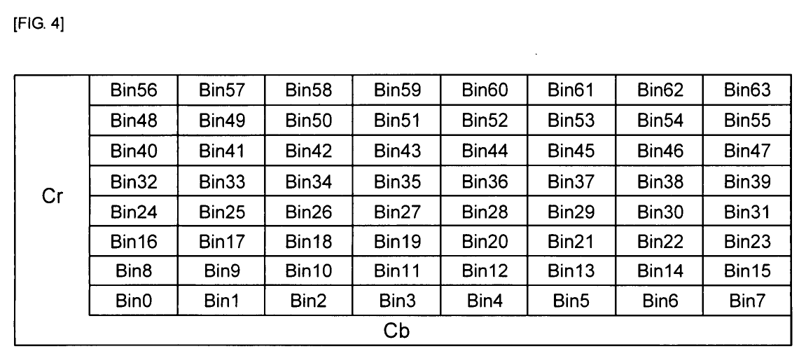

The first histogram setting section 122 is connected to the ISP unit 110 and the first CbCr distribution analyzing section 124. As shown in FIG. 4, the first histogram setting section 122 is composed of a plurality of storing spaces Bin0 to Bin63 which are discriminated depending on Cb and Cr values and can be expanded or reduced. The first histogram setting section 122 analyzes the Cb and Cr values of the image data so as to store the number of pixels corresponding to the Cb and Cr values into each of the storing spaces Bin0 to Bin63, thereby setting a first histogram.

At this time, the Cb and Cr values respectively ranges from 0 to 255, and the respective storing spaces sequentially have Cb and Cr ranges of 32. That is, the Cb value of the horizontal axis is divided into 256 values from the storing space Bin0 to the storing space Bin7. Further, the first storing space Bin0 has a value range of 0 to 31, the second storing space Bin1 has a value range of 32 to 63, and the eighth storing space Bin7 has a value range of 224 to 255.

Similar to the Cb value, the Cr value of the vertical axis is divided into 256 values. The first storing space Bin0 has a value range of 0 to 31, the ninth storing space Bin8 has a value range of 32 to 63, and the 57th storing space Bin56 has a value range of 224 to 255.

Among the Cb and Cr values of the respective pixels of the image data, the number of pixels corresponding to Cr and Cr values of each of the storing spaces Bin0 to Bin63 is stored in the storing space. For example, if the Cb and Cr values of the first pixel are (30, 15), 1 is stored in the first storing space Bin0. If the Cb and Cr values of the second pixel are (2, 28), 2 is stored in the first storing space Bin0.

Further, if the Cb and Cr values of the third pixel are (200, 160), 1 is stored in the 47th storing space Bin46. As the number of pixels corresponding to the Cb and Cr values of each pixel of the image data is stored in the storing spaces, the first histogram is set.

The effective-range central value setting section 123 is connected to the RGB average calculation section 121 and the first CbCr distribution analyzing section 124 and serves to set the effective-range central value of the first histogram from the RGB average of the image data calculated from the RGB average calculation section 121.

The effective-range central value is set by dividing the averages of R and B values by the average of G values among the RGB averages calculated by the RGB average calculation section 121. At this time, the R component of the effective-range central value is set by comparing an R operation value with a first R threshold value which is preset, the R operation value being obtained by dividing the average of the R values by the average of the G values.

If the R operation value is larger than the first R threshold value, 128 and a preset value α are added to the average of the R values of the image data. In the case, α represents a value which can be converted into a value determined by a user.

If the R operation value is smaller than the first R threshold value, the R operation value is compared with a second R threshold value which is preset. At this time, if the R operation value is larger than the second R threshold value, 128 and a preset value β are added to the average of the R values of the image data. In this case, β represents a value which can be converted into a value determined by a user. Further, if the R operation value is smaller than the second R threshold value, 128 is added to the average of the R values of the image data.

Further, the B component of the effective-range central value is set by comparing a B operation value with a first B threshold value which is preset, the B operation value being obtained by dividing the average of the B values by the average of the G values. If the B operation value is larger than the first B threshold value, 128 and the preset value a are added to the average of the B values of the image data.

If the B operation value is smaller than the first B threshold value, the B operation value is compared with a second B threshold value which is preset. At this time, if the B operation value is larger than the second B threshold value, 128 and the preset value β are added to the average of the B values of the image data. Further, if the B operation value is smaller than the second B threshold value, 128 is added to the average of the B values of the image data.

Accordingly, the effective-range central value setting section sets the corrected averages of the R and B values as the effective-range central value. If the R and B components of the effective-range central value are 128 and 160, respectively, the center of the 29th, 30th, 37th, and 38th storing spaces Bin29, Bin30, Bin37, and Bin38 is set to the effective-range central value.

The first CbCr distribution analyzing section 124 is connected to the first histogram setting section 122, the effective-range central value setting section 123, and the effective-range setting section 125. The first CbCr distribution analyzing section 124 stores the number of pixels stored in neighboring 16 storing spaces and the number of pixels stored in neighboring four storing spaces, on the basis of the set effective-range central value.

That is, when the R and B components of the set effective-range central value are 128 and 160, respectively, the center of the 29th, 30th, 37th, and 38th storing spaces Bin29, Bin30, Bin37, and Bin38 is set to the effective-range central value. Accordingly, on the basis of the effective-range central value, 16 neighboring storing spaces are set to Bin19, Bin20, Bin21, Bin22, Bin27, Bin28, Bin29, Bin30, Bin35, Bin36, Bin37, Bin38, Bin43, Bin44, Bin45, and Bin46, and four neighboring storing spaces are set to Bin28, Bin29, Bin36, and Bin37.

As the total number of pixels of the 16 neighboring storing spaces is divided by 16, the average number of pixels of the 16 neighboring storing spaces is calculated. Further, as the total number of pixels of the four neighboring storing spaces is divided by four, the average number of pixels of the four neighboring storing spaces is calculated and then stored.

The effective range setting section 125 is connected to the first CbCr distribution analyzing section 124 and sets an effective range by dividing the average number of pixels of the four neighboring storing spaces, which is stored in the first CbCr distribution analyzing section 124, by the average number of pixels of the 16 neighboring storing spaces.

In the setting of the effective range by the effective range setting section 125, the average number of pixels of the four neighboring storing spaces is divided by the average number of pixels of the 16 neighboring storing spaces so as to calculate an effective-range operation value. The calculated effective-range operation value is compared with a preset effective-range threshold value.

At this time, if the effective-range operation value is larger than the effective-value threshold value, the four storing spaces are set to the effective range. If the effective-range operation value is smaller than the effective-value threshold value, the 16 neighboring storing spaces are set to the effective range.

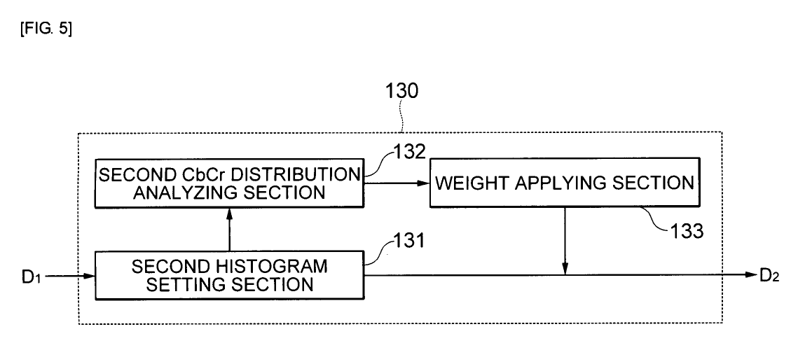

As shown in FIG. 5, the second histogram setting unit 130 includes a second histogram setting section 131, a second CbCr distribution analyzing section 132, and a weight applying section 133. The second histogram setting unit 130 is connected to the first histogram setting unit 120 and the lean setting unit 140 and subdivides the first histogram included in the effective range so as to set a second histogram. Further, the second histogram setting unit 130 applies a weight to the second histogram.

The second histogram setting section 131 includes a plurality of storing spaces F_Bin0 to F_Bin63 which can be expanded and reduced. The second histogram setting section 131 is connected to the first histogram setting unit 120 and the second CbCr distribution analyzing section 132. The second histogram setting section 131 subdivides the first histogram corresponding to the effective range set by the effective-range setting section 125 of the first histogram setting unit 120 and then stores the number of corresponding pixels into each of the storing spaces, thereby setting the second histogram.

For example, when the effective-range set by the effective-range setting section 125 corresponds to 16 neighboring storing spaces on the basis of the effective-range central value, the second histogram setting section 131 expands the range of four storing spaces of the Cb axis, that is, a range of 96 to 223 into a range of F_Bin0 to F_Bin7 and then stores the number of corresponding pixels. Further, the second histogram setting section 131 expands the range of four storing spaces of the Cr axis, that is, a range of 64 to 191 into a range of F_Bin0 to F_Bin56 and then stores the number of corresponding pixels. In this case, one storing space has Cb and Cb ranges of 16.

If the Cb and Cr values of a pixel stored in the storing space Bin19 of the first histogram are (98, 65), it is stored in the first storing space F_Bin0 of the second histogram. When the Cb and Cr values of a pixel stored in the storing space Bin21 are (170, 145), it is stored in the 45th storing space F_Bin44 of the second histogram.

As such, by using the effective range and the effective-range central value set by the first histogram setting unit 120, the second histogram setting section 131 subdivides the first histogram included in the effective range, thereby setting the second histogram.

The second CbCr distribution analyzing section 132 is connected to the second histogram setting section 131 and the weight applying section 133. The second CbCr distribution analyzing section 132 sets nine neighboring storing spaces of the set second histogram to one block. Among the storing spaces, a storing space in which the largest number of pixels is stored is set to a peak storing space.

For example, the storing spaces F_Bin0, F_Bin1, F_Bin2, F_Bin8, F_Bin9, F_Bin10, F_Bin16, F_Bin17, and F_Bin18 are set to one block and the storing spaces F_Bin1, F_Bin2, F_Bin3, F_Bin9, F_Bin10, F_Bin11, F_Bin17, F_Bin18, and F_Bin19 are set to one block. As the setting is repeatedly performed, 36 blocks can be set. Among the storing spaces of each block, a storing space in which the largest number of pixels is stored is set to a peak storing space.

The weight applying section 133 is connected to the second CbCr distribution analyzing section 132 and calculates a peak operation value by dividing the number of pixels of the peak storing space of each block by the average number of pixels stored in neighboring eight storing spaces.

The peak operation value is compared with a preset white threshold value. If the peak operation value is larger than the white threshold value, the weight applying section 133 applies a weight by multiplying any one weight selected from ½, ⅓, and 0 by the number of pixels of the peak storing space.

At this time, if the peak operation value is smaller than the white threshold value, the weight apply section 133 applies a weight by multiplying any one weight, selected from 2 and 3, by the number of pixels of the peak storing space.

The lean setting unit 140 is connected to the second histogram setting unit 130 and the ISP unit 110. The lean setting unit 140 calculates a lean correction value by applying preset lean values by the second histogram to which the weight has been applied. Further, the lean setting unit 140 delivers the calculated lean correction value to the ISP unit 110.

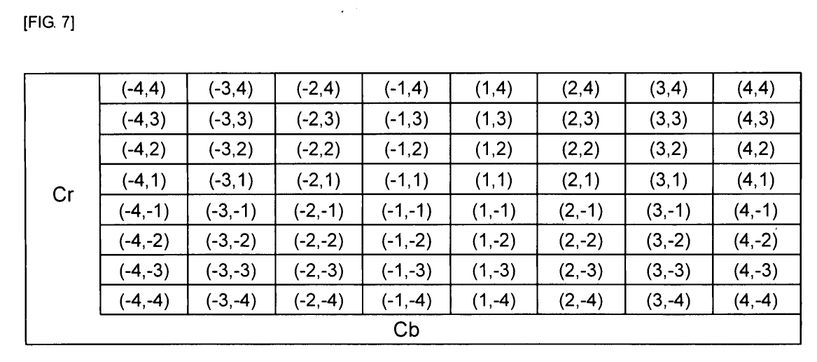

At this time, before the lean values are applied, the lean setting unit 140 calculates the total number F_total of pixels of the respective storing spaces of the second histogram to which the weight has been applied. Then, the lean setting unit 140 multiplies the second histogram, to which the weight has been applied by the weight applying section 133 of the second histogram setting unit 130, by the preset lean values, as shown in FIG. 7.

For the respective storing spaces of the second histogram, the sum total Cb_total of Cb values and the sum total Cr_total of Cr values are calculated. Then, the calculated sum totals Cb_total and Cb_total are respectively divided by the total number F_total, thereby calculating (Cb_lean, Cr_lean).

After (Cb_lean, Cr_lean) is calculated, the Cb and Cr values of the central value set by the effective-range central value setting section 123 are added to (Cb_lean, Cr_lean), thereby calculating (Cb_error, Cb_error).

Further, (R_error, G_error, B_error) is calculated, which is an RGB value corresponding to a YCbCr value (128, Cb_error, Cr_error). The G_error is divided by the R_error so as to calculate an R correction value, and the G_error is divided by the B_error so as to calculate a B correction value. Then, a lean correction value (R correction value, 1, B correction value) is calculated.

The calculated lean correction value is delivered to the ISP unit 110 so as to be applied to the image data. Then, the white balance of the image data is automatically adjusted, so that excellent color representation can be achieved.

Hereinafter, a method for automatically adjusting white balance according to an embodiment of the invention will be described in detail with reference to the accompanying drawings.

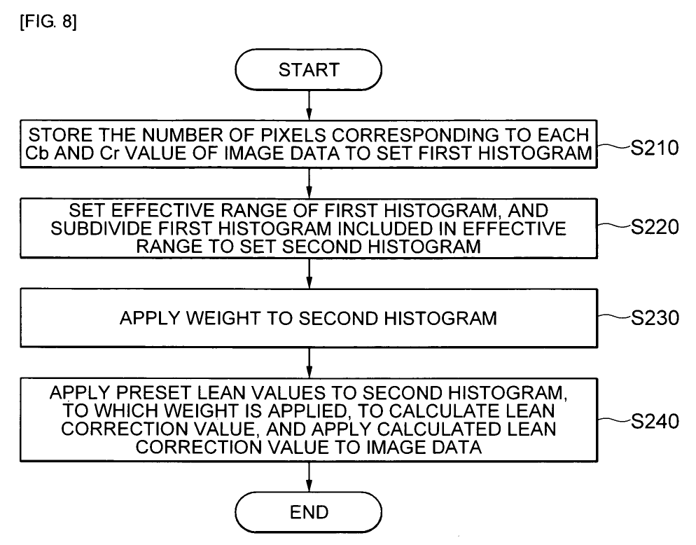

FIG. 8 is a flow chart showing a method for automatically adjusting white balance according to an embodiment of the invention.

As shown in FIG. 8, the number of pixels corresponding to each Cb and Cr value of image data is stored to set a first histogram (step S210).

After the first histogram is set, an effective range of the first histogram is set, and the first histogram included in the effective range is subdivided to set a second histogram (step S220).

A weight is applied to the second histogram set at step S220 (step S230).

Preset lean values are applied to the second histogram, to which the weight has been applied, so as to calculate a lean correction value, and the calculated lean correction value is applied to the image data (step S240).

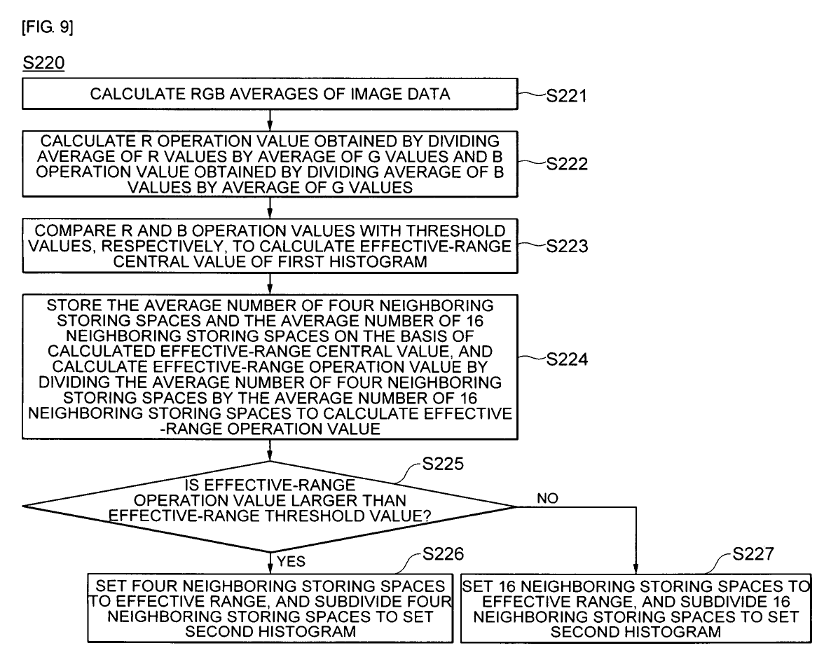

FIG. 9 is a flow chart showing step S220 in more detail. As shown in FIG. 9, the averages of R, G, and B values of the image data are calculated (step S221).

Among the RGB averages calculated at step S221, the average of R values is divided by the average of G values so as to calculate an R operation value, and the average of B values is divided by the average of G values so as to calculate a B operation value (step S222).

The R and B operation values calculated at step S222 are compared with threshold values, respectively, so as to calculate an effective-range central value of the first histogram (step S223).

After the effective-range central value of the first histogram is calculated, the average number of pixels of four neighboring storing spaces and the average number of pixels of 16 neighboring storing spaces are calculated on the basis of the calculated effective-range central value, and the average number of pixels of four neighboring storing spaces is divided by the average number of pixels of 16 neighboring storing spaces so as to calculate an effective-range operation value (step S224).

The effective-range operation value calculated in such a manner is compared with a preset effective-range threshold value. When the effective-range operation value is larger than the effective-range threshold value, the four storing spaces are set to an effective range. Then, the four storing spaces are subdivided to set a second histogram (steps S225 and S226).

If the effective-range operation value is smaller than the effective-range threshold value, the 16 storing spaces are set to an effective range. Then, the 16 storing spaces are subdivided to set a second histogram (step S227).

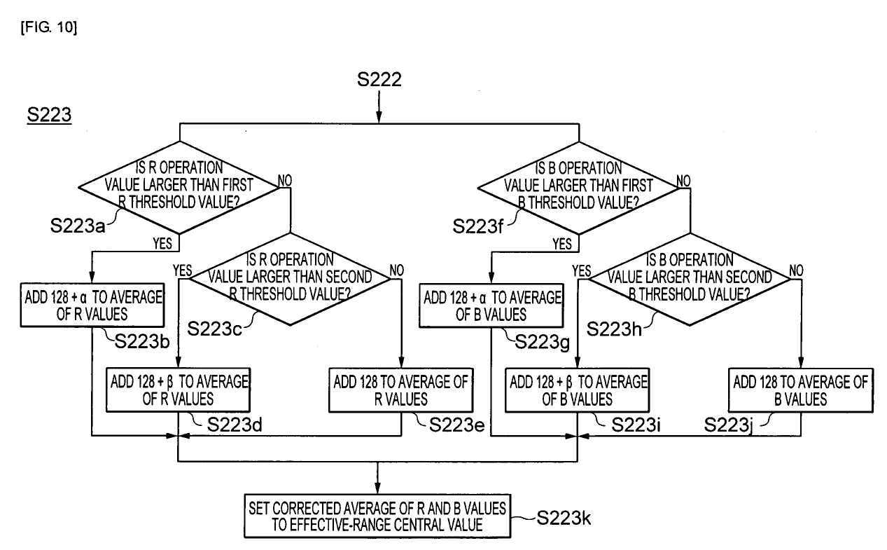

FIG. 10 is a flow chart showing step S223 in detail. At step S223, the effective-range central value is set by dividing the averages of R and B values, among the calculated RGB averages, by the average of G values. At this time, as shown in FIG. 10, the R component of the effective-range central value is set by the following process. An R operation value obtained by dividing the average of R values by the average of G values is compared with a first R threshold value which is preset (step S223a).

At this time, if the R operation value is larger than the first R threshold value, 128 and a preset value a are added to the average of R values of the image data. In this case, a represents a certain value which can be converted to a value determined by a user (step S223b).

If the R operation value is smaller than the first R threshold value, the R operation value is compared with a second R threshold value which is preset (step S223c). If the R operation value is larger than the second R threshold value, 128 and a preset value β are added to the average of R values of the image data (step S223d). At this time, β represents a certain value which can be converted to a value determined by a user. Further, if the R operation value is smaller than the second R threshold value, 128 is added to the average of R values of the image data (step S223e).

The B component of the effective-range central value is obtained by the following process. A B operation value obtained by dividing the average of B values by the average of G values is compared with a first B threshold value which is preset (step S223f). When the B operation value is larger than the first B threshold value, 128 and the preset value a are added to the average of B values of the image data (step S223g).

If the B operation value is smaller than the first B threshold value, the B operation value is compared with a second B threshold value which is preset (step S223h). At this time, when the B operation value is larger than the second B threshold value, 128 and the preset value β are added to the average of B values of the image data (S223i). When the B operation value is smaller than the second B threshold value, 128 is added to the average of B values of the image data (step S223j).

Accordingly, the corrected averages of R and B values are set to a effective-range central value (step S223k). If the R and B values of the set effective-range central value are 128 and 160, respectively, the center of the 29th, 30th, 37th, and 38th storing spaces Bin29, Bin30, Bin37, and Bin38 of FIG. 4 is set to the effective-range central value.

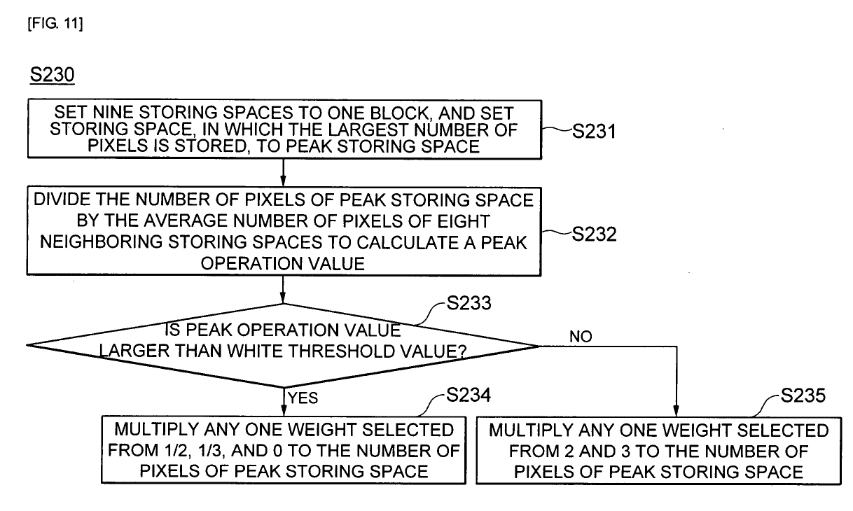

FIG. 11 is a flow chart showing step S230 in more detail. As shown in FIG. 11, nine storing spaces are set to one block. Among the storing spaces of each block, a storing space in which the largest number of pixels is stored is set to a peak storing space (S231).

The number of pixels of the set peak storing space is divided by the average number of pixels of eight storing spaces around the peak storing space so as to calculate a peak operation value (step S232).

The calculated peak operation value is compared with a white threshold value which is preset (step S233). When the peak operation value is larger than the white threshold value, any one weight selected from ½, ⅓, and 0 is multiplied by the number of pixels of the peak storing space. In this way, the weight is applied to the second histogram (step S234).

If the peak operation value is smaller than the white threshold value, any one weight selected from 2 and 3 is multiplied by the number of pixels of the peak storing space. In this way, the weight is applied to the second histogram (step S235).

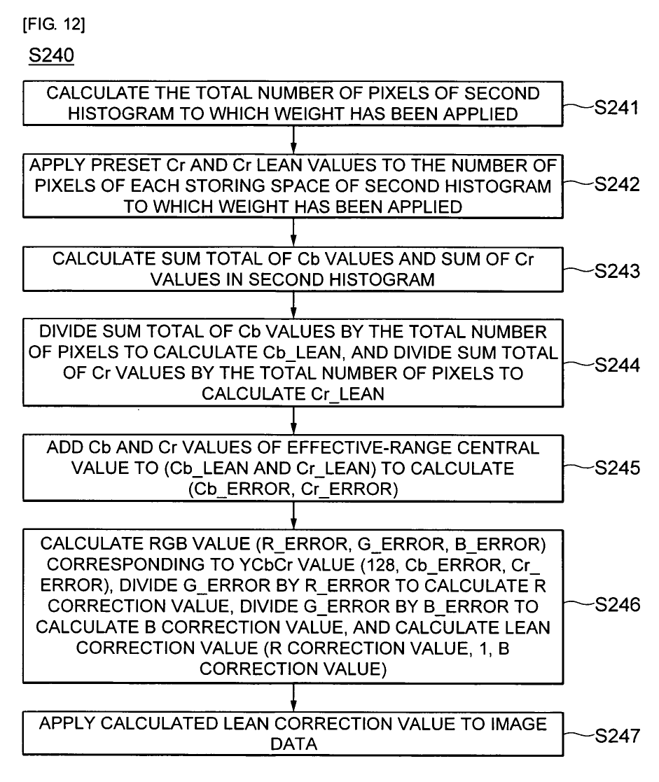

FIG. 12 is a flow chart showing step S240 in more detail. As shown in FIG. 12, the total number F_total of pixels of the second histogram to which the weight has been applied is calculated (step S241).

A preset lean value is applied to the number of pixels of each storing space of the second histogram to which the weight has been applied (step S242). Then, the Cb and Cr values of all the storing spaces of the second histogram are added up so as to calculate the sum total Cb_total of the Cb values and the sum total Cr_total of the Cr values (step S243).

After the sum totals Cb_total and Cr_total are calculated, the sum total Cb_total is divided by the total number F_total so as to calculate Cb_lean, and the sub total Cr_total is divided by the total number F_total so as to calculate Cb_lean (step S244).

The calculated (Cb_lean, Cr_lean) is added to the Cb and Cr values of the effective-range central value, respectively, thereby calculating (Cb_error, Cr_error) (step S245).

Next, an RGB value (R_error, G_error, B_error) corresponding to a YCbCr value (128, Cb_error, Cr_error) is calculated. Then, the G_error is divided by the R_error so as to calculate an R correction value, and the G_error is divided by the B_error so as to calculate a B correction value. Accordingly, a lean correction value (R correction value, 1, B correction value) is calculated (step S246).

Then, as the calculated lean correction value is applied to the image data, the white balance of the image data can be automatically adjusted (step S247).

While the present invention has been described with reference to exemplary embodiments thereof, it will be understood by those skilled in the art that various changes and modifications in form and detail may be made therein without departing from the scope of the present invention as defined by the following claims.

### EFFECT OF THE INVENTION

According to the apparatus and method for automatically adjusting white balance, a low weight is applied to a region of image data in which a probability that the original color thereof is gray is low, and a high weight is applied to a region of the image data in which a probability that the original color thereof is gray is high, through the first and second histograms of image data. Then, white balance can be automatically adjusted, so that excellent color representation can be achieved.

1. An apparatus for automatically adjusting white balance, the apparatus comprising:
an Image Signal Processing (ISP) unit that processes image data;
a first histogram setting unit that is connected to the ISP unit, stores the number of pixels corresponding to each Cb and Cr value of the image data applied from the ISP unit so as to set a first histogram, and sets an effective range of the first histogram;
a second histogram setting unit that is connected to the first histogram setting unit, subdivides the first histogram included in the effective range so as to set a second histogram, and applies a weight to the second histogram; and
a lean setting unit that is connected to the second histogram setting unit, applies preset lean values to the second histogram, to which the weight has been applied, so as to calculate a lean correction value, and delivers the calculated correction value to the ISP unit.

2. The apparatus according to claim 1, wherein the first histogram setting unit includes:
an RGB calculation section that calculates the averages of R, G, and B values of the image data;
a first histogram setting section that is composed of a plurality of storing spaces, which are discriminated depending on the Cb and Cr values and can be expanded or reduced, analyzes the respective Cb and Cr values of the image data, and stores the number of pixels corresponding to the Cb and Cr values to each of the storing spaces so as to set the first histogram;
an effective-range central value setting section that is connected to the RGB calculation section and sets an effective-range central value of the first histogram from the RGB averages of the image data;
a first CbCr distribution analyzing section that is connected to the first histogram setting section and the effective-range central value setting section, calculates the average number of pixels of 16 neighboring storing spaces and the average number of pixels of four neighboring storing spaces on the basis of the set effective-range central value, and stores the average numbers; and
an effective range setting section that is connected to the first CbCr distribution analyzing section and divides the average number of pixels of four neighboring storing spaces by the average number of pixels of 16 neighboring storing spaces, thereby setting an effective range.

3. The apparatus according to claim 2, wherein the respective storing spaces of the first histogram setting section sequentially have Cr and Cb ranges of 32 in the range of 0 to 255.

4. The apparatus according to claim 2, wherein when an effective-range operation value obtained by dividing the average number of pixels of the four neighboring storing spaces by the average number of pixels of the 16 neighboring storing spaces is larger than a preset effective-range threshold value, the effective range setting section sets the four neighboring storing spaces to an effective range.

5. The apparatus according to claim 2, wherein when an effective-range operation value obtained by dividing the average number of pixels of the four neighboring storing spaces by the average number of pixels of the 16 neighboring storing spaces is smaller than a preset effective-range threshold value, the effective range setting section sets the 16 neighboring storing spaces to an effective range.

6. The apparatus according to claim 1, wherein the second histogram setting unit includes:
a second histogram setting section that is composed of a plurality of storing spaces which can be expanded or reduced, subdivides the first histogram corresponding to the effective range set by the first histogram setting unit, and stores the number of corresponding pixels into each of the storing spaces so as to set the second histogram;
a second CbCr distribution analyzing section that is connected to the second histogram setting section, sets nine storing spaces to one block, and then sets a storing space, in which the largest number of pixels is stored, to a peak storing space; and
a weight applying section that is connected to the second CbCr distribution analyzing section, calculates a peak operation value by dividing the number of pixels of the set peak storing space by the average number of pixels of eight neighboring storing spaces, and compares the calculated peak operation value with a preset white threshold value so as to calculate and apply a weight.

7. The apparatus according to claim 6, wherein when the peak operation value is larger than the white threshold value, any one weight selected from ½, ⅓, and 0 is multiplied by the number of pixels of the peak storing space.

8. The apparatus according to claim 6, wherein when the peak operation value is smaller than the white threshold value, any one weight selected from 2 and 3 is multiplied by the number of pixels of the peak storing space.

9. A method for automatically adjusting white balance, the method comprising the steps of:
(a) storing the number of pixels corresponding to each Cb and Cr value of image data so as to set a first histogram;
(b) setting an effective range of the set first histogram, and subdividing the first histogram included in the effective range so as to set a second histogram;
(c) applying a weight to the second histogram; and
(d) applying preset lean values to the second histogram, to which the weight has been applied, so as to calculate a lean correction value, and applying the calculated lean correction value to the image data.

10. The method according to claim 9, wherein step (b) includes the steps of:
(b-1) calculating the averages of R, G, and B values of the image data;
(b-2) calculating an R operation value obtained by dividing the average of R values by the average of G values and a B operation value obtained by dividing the average of B values and the average of G values;
(b-3) comparing the R and B operation values with threshold values, respectively, so as to calculate an effective-range central value of the first histogram;
(b-4) calculating an effective-range operation value by dividing the average number of pixels of four neighboring storing spaces by the average number of pixels of 16 neighboring storing spaces on the basis of the calculated effective-range central value;
(b-5) comparing the calculated effective-range operation value with a preset effective-range threshold value; and
(b-6) when the effective-range operation value is larger than the effective-range threshold value, setting the four storing spaces to an effective range, and subdividing the four storing spaces so as to set the second histogram.

11. The method according to claim 10, wherein when the effective-range operation value is smaller than the effective-range threshold value at step (b-5), the 16 neighboring storing spaces are set to an effective range, and then are subdivided so as to set the second histogram.

12. The method according to claim 10, wherein the calculating of the R component of the effective-range value at step (b-3) includes the steps of:
(b-31) comparing the calculated R operation value with a first R threshold value which is preset;
(b-32) when the R operation value is larger than the first R threshold value, adding 128+α to the average of R values; and
(b-33) setting the corrected average of R values to the R component of the effective-range central value.

13. The method according to claim 12, wherein the calculating of the R component of the effective-range value at step (b-3) further includes the steps of:
(b-34) when the R operation value is smaller than the first R threshold value at step (b-31), comparing the R operation value with a second R threshold value which is preset; and
(b-35) when the R operation value is larger than the second R threshold value, adding 128+β to the average of R values.

14. The method according to claim 13, wherein when the R operation value is smaller than the second R threshold value at step (b-34), 128 is added to the average of R values.

15. The method according to claim 10, wherein the calculating of the B component of the effective-range value at step (b-3) includes the steps of:
(b-36) comparing the calculated B operation value with a first B threshold value which is preset;
(b-37) when the B operation value is larger than the first B threshold value, adding 128+α to the average of B values; and
(b-38) setting the corrected average of B values to the B component of the effective-range central value.

16. The method according to claim 15, wherein the calculating of the B component of the effective-range value at step (b-3) includes the steps of:
(b-39) when the B operation value is smaller than the first B threshold value at step (b-36), comparing the B operation value with a second B threshold value which is preset; and
(b-40) when the B operation value is larger than the second B threshold value, adding 128+β to the average of B values.

17. The method according to claim 13, wherein when the B operation value is smaller than the second B threshold value at step (b-39), 128 is added to the average of B values.

18. The method according to claim 9, wherein step (c) includes the steps of:
(c-1) setting nine storing spaces to one block, and then setting a storing space, in which the largest number of pixels is stored, to a peak storing space;
(c-2) dividing the number of pixels of the peak storing space by the average number of pixels of eight neighboring storing spaces so as to calculate a peak operation value;
(c-3) comparing the calculated peak operation value with a white threshold value which is preset;
(c-4) when the peak operation value is larger than the white threshold value, multiplying any one weight selected from ½, ⅓, and 0 by the number of pixels of the peak storing space so as to apply the weight.

19. The method according to claim 18, wherein when the peak operation value is smaller than the white threshold value at step (c-3), any one weight selected from 2 and 3 is multiplied by the number of pixels of the peak storing space so as to apply the weight.

20. The method according to claim 9, wherein step (d) includes the steps of:
(d-1) calculating the total number of pixels of the second histogram, to which the weight has been applied;
(d-2) applying a preset lean value to the number of pixels of each storing space of the second histogram, to which the weight has been applied;
(d-3) calculating the sum total of the Cb values and the sum total of the Cr values in the second histogram;
(d-4) dividing the sum total of Cb values by the total number of pixels of the second histogram so as to calculate Cb_lean, and dividing the sum total of Cr values by the total number of pixels of the second histogram so as to calculate Cr_lean;
(d-5) adding the Cb and Cr values of the effective-range central value to (Cb_lean and Cr_lean) so as to calculate (Cb_error, Cr_error);
(d-6) calculating an RGB value (R_error, G_error, B_error) corresponding to a YCbCr value (128, Cb_error, Cr_error), dividing the G_error by the R_error so as to calculate an R correction value, and dividing the G_error by the B_error so as to calculate a B correction value, thereby obtaining a lean correction value (R correction value, 1, B correction value); and
(d-7) applying the calculated correction value to the image data.
